(19) United States
(12) Patent Application Publication
(10) Pub. No.: US 2014/0266878 A1
(43) Pub. Date: Sep. 18, 2014

(54) OBJECT ORIENTATION TRACKER

(71) Applicant: THALES VISIONIX, INC., Clarksburg, MD (US)

(72) Inventors: Robert B. ATAC, Batavia, IL (US); Eric FOXLIN, Lexington, MA (US)

(73) Assignee: THALES VISIONIX, INC., Clarksburg, MD (US)

(21) Appl. No.: 14/209,773

(22) Filed: Mar. 13, 2014

Related U.S. Application Data
(60) Provisional application No. 61/799,686, filed on Mar. 15, 2013.

(51) Int. Cl. G01S 19/10

(52) U.S. Cl. CPC G01S 19/10
USPC 342/357.47

(57) ABSTRACT

Aspects of the present invention relate to systems, methods, and computer program products for tracking an orientation of an object. The system includes a first sensor that measures the orientation of the object relative to an external reference frame and generates an orientation signal based on the measured orientation of the object, the first sensor being subject to drift over time; a second sensor that receives a global positioning system (GPS) signal and generates a drift compensation signal based on the received GPS signal; and a processor coupled to the first sensor and the second sensor, the processor generating a drift-corrected orientation signal based on the orientation signal from the first sensor and the drift compensation signal from the second sensor.

### CLAIM OF PRIORITY UNDER 35 U.S.C. §119

This application claims the benefit of and priority to U.S. Provisional Patent Application No. 61/799,686, titled “Object Orientation Tracker,” filed Mar. 15, 2013, the disclosure of which is hereby incorporated in its entirety by reference herein.

### BACKGROUND

Aspects of the present invention generally relate to a system and method for tracking orientation of an object and, more particularly, to a system and method for tracking orientation of a helmet worn by a user that corrects for drift measured by an inertial measurement device when the user moves the helmet.

### SUMMARY

According to an aspect of the present invention, a system for tracking an orientation of an object may include a first sensor that measures the orientation of the object relative to an external reference frame and generates an orientation signal based on the measured orientation of the object, the first sensor being subject to drift over time; a second sensor that receives a global positioning system (GPS) signal and generates a drift compensation signal based on the received GPS signal; and a processor coupled to the first sensor and the second sensor, the processor generating a drift-corrected orientation signal based on the orientation signal from the first sensor and the drift compensation signal from the second sensor.

According to another aspect of the present invention, a method for tracking an orientation of an object may include measuring the orientation of the object relative to an external reference frame using a first sensor; generating an orientation signal based on the measured orientation of the object using the first sensor, the first sensor being subject to drift over time; receiving a global positioning system (GPS) signal using a second sensor; generating a drift compensation signal based on the received GPS signal using the second sensor; and generating a drift-corrected orientation signal based on the orientation signal from the first sensor and the drift compensation signal from the second sensor using a processor coupled to the first and second sensor.

According to another aspect of the present invention, a system for tracking an orientation of an object may include means for measuring the orientation of the object relative to an external reference frame using a first sensor; means for generating an orientation signal based on the measured orientation of the object using the first sensor, the first sensor being subject to drift over time; means for receiving a global positioning system (GPS) signal using a second sensor; means for generating a drift compensation signal based on the received GPS signal using the second sensor; and means for generating a drift-corrected orientation signal based on the orientation signal from the first sensor and the drift compensation signal from the second sensor using a processor coupled to the first and second sensor.

According to yet another aspect of the present invention, a computer program product may include a non-transitory computer-readable medium having control logic stored therein for causing a computer to control a tracking of an orientation of an object, the control logic including code for measuring the orientation of the object relative to an external reference frame using a first sensor; code for generating an orientation signal based on the measured orientation of the object using the first sensor, the first sensor being subject to drift over time; and code for receiving a global positioning system (GPS) signal using a second sensor; code for generating a drift compensation signal based on the received GPS signal using the second sensor; and code for generating a drift-corrected orientation signal based on the orientation signal from the first sensor and the drift compensation signal from the second sensor using a processor coupled to the first and second sensor.

It is understood that other aspects of the invention will become readily apparent to those skilled in the art from the following detailed description, wherein various aspects of the present invention are shown and described by way of illustration only. As will be understood, the present invention is capable of other and different variations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is a schematic diagram of a system for tracking the orientation of an object in accordance with an exemplary aspect of the present invention;

FIG. 2 is a perspective view of a helmet having an aspect of the system shown in FIG. 1 in accordance with an exemplary aspect of the present invention;

FIG. 3 depicts an example flow diagram of a method for tracking an orientation of an object in accordance with aspects of the present invention; and

FIG. 4 depicts a computer system for implementing various aspects of the present invention.

In accordance with common practice, the various features illustrated in the drawings may be simplified for clarity. Thus, the drawings may not depict all of the components of a given apparatus or method. In addition, like reference numerals may be used to denote like features throughout the specification and figures.

### DETAILED DESCRIPTION

Various aspects of the present invention are described below. It should be apparent that the teachings herein may be embodied in a wide variety of forms and that any specific structure, function, or both being disclosed herein may be merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

Referring to the drawings in detail, wherein like reference numerals indicate like elements throughout, there is shown in FIGS. 1-2, systems and methods for tracking an orientation of an object in accordance with exemplary aspects of the present invention. The words “system” and “method” as used herein are used interchangeably and are not intended to be limiting.

There are many different situations where it is helpful to know the position and orientation of a person. For example, by tracking a person's position and orientation, ground helmet tracking systems can generate an image for a helmet-mounted display that is based on the person's position and orientation. In order to determine the position and orientation of a person, these systems need to determine the azimuth, elevation and roll of a helmet relative to the earth. Generally, ground helmet tracking systems use an inertial measurement unit and a 3-axis magnetometer to track a person's position and orientation. One type of inertial measurement unit measures the orientation of an object using accelerometers and gyroscopes. One example of a ground helmet tracking system is disclosed in U.S. Pat. No. 7,301,648 (“the '648 patent”). The '648 patent discloses an inertial head orientation module that includes tiny piezoelectric camcorder gyros, solid-state accelerometers and magnetometers to track position and orientation. The '648 patent is fully incorporated by reference herein in its entirety. Unfortunately, gyroscopes and accelerometers are both sensitive to noise (i.e. an unintended random deviation in the output signal). Because these sensors produce a signal that is integrated over time to calculate the angular or linear orientation of an object, the noise in the sensor signals is also integrated over time, meaning the noise slowly accumulates in the output signal and may eventually result in significant error in the final output signal.

The inertial measurement unit can be kept from drifting in pitch and roll using the earth's gravitational field. Gravimetric tilt sensors can be used to correct for pitch and roll sensor drift because a gravitational force remains the same for an object rotating horizontally relative to the earth. However, gravimetric tilt sensors cannot be used to correct for heading or azimuth angle. Instead, magnetometers can be used to correct for this type of drift in the accelerometer. The magnetometer measures azimuth orientation by measuring the direction of the earth's magnetic field relative to the magnetometer. As the magnetometer rotates horizontally relative to the earth, the magnetometer measures direction of the earth's magnetic field, and outputs a signal that represents the measured direction.

However, magnetometers may be subject to sensor drift in environments where the earth's magnetic field is distorted, e.g. metal structures, vehicles, etc. Because the sensor drift error may be introduced to the magnetometer output, the magnetometer may not correctly compensate for drift correction for the accelerometers.

In one aspect, a ground helmet tracking system is provided that improves the computation of an azimuth orientation of a helmet even in the presence of metallic objects. By minimizing the effects of metallic objects on a ground helmet tracking system, a ground helmet tracking system can improve computation of the orientation of a helmet even when the helmet is near metallic objects.

Referring to FIG. 1, there is shown a system 10 for tracking the orientation of an object in accordance with an exemplary aspect of the invention. In one aspect, system 10 includes a first sensor 2 that measures the orientation of an object relative to an external reference frame and generates an orientation signal based on the measured orientation of the object. In one aspect, first sensor 2 is an inertial measurement unit. In one aspect, first sensor 2 is subject to drift over time. In one aspect, system 10 includes a second sensor 4 that receives a global positioning system (GPS) signal. In one aspect, second sensor 4 is a GPS receiver. In one aspect, second sensor 4 generates a drift compensation signal based on the received GPS signal. In one aspect, system 10 includes a processor 6 that is coupled to first sensor 2 and second sensor 4. In one aspect, processor 6 generates a drift-corrected orientation signal based on an orientation signal from first sensor 2 and a drift compensation signal from second sensor 4.

In one aspect, system 10 includes an inertial measurement unit 2 (“IMU”) that measures the orientation of the system relative to an external reference frame. In one aspect, system 10 includes a global positioning system (“GPS”) receiver 4 that measures an azimuth angle of system 10 relative to an external reference frame. In one aspect, system 10 includes a processor 6 that computes a drift correction signal for IMU 6, to correct drift error accumulated in IMU 6, based on the azimuth angle measured by GPS receiver 4.

In one aspect, IMU 2 is an electronic device that measures the orientation of an object relative to an external reference frame. In one aspect, IMU 2 may include an accelerometer that measures the inertial acceleration of the object relative to an external reference frame, and outputs the measurement as a signal. In one aspect, IMU 2 may include three accelerometers. In one aspect, IMU 2 may include three accelerometers that are arranged such that the measuring axes of each accelerometer are orthogonal to each other. In one aspect, IMU 2 generates an inertial acceleration signal that represents the linear movement of an object relative to an external reference frame.

In one aspect, IMU 2 may include a gyroscope that measures rotational acceleration of an object relative to an external reference frame, and outputs the measurement as a signal. In one aspect, IMU 2 may include three gyroscopes. In one aspect, the IMU 2 may include three gyroscopes that are arranged such that the measuring axes of each gyroscope are orthogonal to each other. In one aspect, IMU 2 generates a rotational acceleration signal that represents the rotational movement of an object relative to an external reference frame.

In one aspect, GPS receiver 4 may be used to compensate for drift even while the device is in a distorted magnetic field environment. In one aspect, GPS receiver 4 may include an antenna 8 that receives a GPS signal from a GPS satellite. In one aspect, GPS receiver 4 calculates a latitude and longitude of system 10 using the GPS signal received by antenna 8. In one aspect, GPS receiver 4 may calculate an azimuth angle of the system and generate an azimuth angle signal based on the received GPS signal. In one aspect, the azimuth angle may be defined as a horizontal angle measured clockwise from a north base line or meridian. In one aspect, GPS receiver 4 may be mounted to an object (e.g. a helmet). In one aspect, GPS receiver 4 may be a GPS compass. In one aspect, GPS compass 4 may calculate an azimuth angle by comparing latitude and longitude data from a current GPS signal received by antenna 8 to latitude and longitude data from a previous GPS signal received by antenna 8 and calculating a direction of movement, or bearing, of GPS compass 4. Once the direction of movement, or bearing, is calculated, GPS compass 4 can calculate the azimuth angle.

In one aspect, GPS receiver 4 may be two or more GPS receivers. In one aspect, GPS receivers 4 may calculate an azimuth angle by comparing a current GPS signal of one GPS receiver 4 to a current GPS signal of another GPS receiver 4.

In one aspect, processor 6 may be connected to IMU 2 via connection line 3. In one aspect, connection line 3 is a wired connection line. In another aspect, connection line 3 is a wireless connection line. In one aspect, IMU 2 may transmit an inertial acceleration signal and a rotational acceleration signal to processor 6 via connection line 3. In one aspect, processor 6 may be connected to the GPS receiver 4 via connection line 5. In one aspect, connection line 5 is a wired connection line. In another aspect, connection line 5 is a wireless connection line. In one aspect, GPS receiver 4 may transmit the azimuth angle signal or the latitude and longitude signal to processor 6. In one aspect, processor 6 extracts inertial acceleration data from the inertial acceleration signal, rotational acceleration data from the rotational acceleration signal, and azimuth angle data from the azimuth angle signal. In one aspect, processor 6 calculates an azimuth angle measured by IMU 2 based on the inertial acceleration data and the rotational acceleration data. In one aspect, processor 6 compares the azimuth angle from IMU 2 to the azimuth angle measured by GPS receiver 4. In one aspect, processor 6 computes a drift-corrected azimuth signal based on the difference between the azimuth angle measured by the IMU 2 and the azimuth angle measured by the GPS receiver 4. In one aspect, after computing the drift-corrected azimuth signal, processor 6 transmits the drift-corrected azimuth signal to the IMU 2 via connection line 3. In one aspect, IMU 2 receives the drift-corrected signal from processor 6 and adjusts its inertial acceleration measurements and angular acceleration measurements accordingly.

Referring to FIG. 2, system 10 may be mounted to an object such as helmet 12 for tracking an orientation of an object. In one aspect, IMU 2, GPS receiver 4 and processor 6 may be enclosed in a housing 14 that is mounted to helmet 12. In one aspect, as helmet 12 moves, system 10 measures the movement of helmet 12, and computes the orientation of helmet 12 according to the aspects described above with regard to FIG. 1. It is understood that system 10 could be mounted to other objects besides a helmet (e.g. an airplane, a shoe, a vehicle).

In one aspect, system 10 includes one or more computers having one or more processors and memory (e.g., one or more nonvolatile storage devices). In some aspects, memory or computer readable storage medium of memory stores programs, modules and data structures, or a subset thereof for a processor to control and run the various systems and methods disclosed herein. In one aspect, a non-transitory computer readable storage medium having stored thereon computer-executable instructions which, when executed by a processor, perform one or more of the methods disclosed herein.

FIG. 3 illustrates an example flow diagram of a method 300 for tracking an orientation of an object in accordance with aspects of the present invention. As shown in FIG. 3, in block 302, the orientation of the object relative to an external reference frame is measured using a first sensor.

In block 304, an orientation signal is generated based on the measured orientation of the object using the first sensor, the first sensor being subject to drift over time.

In block 306, a global positioning system (GPS) signal is received using a second sensor.

In block 308, a drift compensation signal is generated based on the received GPS signal using the second sensor.

In block 310, a drift-corrected orientation signal is generated based on the orientation signal from the first sensor and the drift compensation signal from the second sensor using a processor coupled to the first and second sensor.

Aspects of the present invention may be implemented using hardware, software, or a combination thereof and may be implemented in one or more computer systems or other processing systems. In one variation, aspects of the invention are directed toward one or more computer systems capable of carrying out the functionality described herein. An example of such a computer system 700 is shown in FIG. 4.

Computer system 700 includes one or more processors, such as processor 704. The processor 704 is connected to a communication infrastructure 706 (e.g., a communications bus, a cross-over bar, or a network). Various software aspects are described in terms of this exemplary computer system. After reading this description, it will become apparent to a person skilled in the relevant art(s) how to implement aspects of the invention using other computer systems and/or architectures.

Computer system 700 can include a display interface 702 that forwards graphics, text, and other data from the communication infrastructure 706 (or from a frame buffer not shown) for display on a display unit 730. Computer system 700 also includes a main memory 708, such as random-access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well-known manner. Removable storage unit 718 represents a floppy disk, a magnetic tape, a thumb drive, an optical disk, etc., which is read by and written to removable storage drive 714. As will be appreciated, the removable storage unit 718 includes a computer usable storage medium having stored therein computer software and/or data.

In alternative variations, secondary memory 710 may include other similar devices for allowing computer programs or other instructions to be loaded into computer system 700. Such devices may include, for example, a removable storage unit 722 and an interface 720. Examples of such may include a program cartridge and a cartridge interface (such as that found in video game devices), a removable memory chip (such as an erasable programmable read-only memory (EPROM) or a programmable read-only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals, which may be electronic, electromagnetic, optical, or other signals capable of being received by communications interface 724. These signals are provided to communications interface 724 via a communications path (e.g., channel) 726. This path 726 carries signals and may be implemented using wire or cable, fiber optics, a telephone line, a cellular link, a radio frequency (RF) link, and/or other communications channels. In this document, the terms “computer program medium,” “computer-usable medium,” and “computer-readable medium” are used to refer generally to media such as a removable storage drive 714, a hard disk installed in hard disk drive 712, and signals. These computer program products provide software to the computer system 700. Aspects of the invention are directed to such computer program products.

Computer programs (also referred to as computer control logics) are stored in main memory 708 and/or secondary memory 710. Computer programs may also be received via communications interface 724. Such computer programs, when executed, enable the computer system 700 to perform the features in accordance with aspects of the present invention, as discussed herein. In particular, the computer programs, when executed, enable the processor 704 to perform such features. Accordingly, such computer programs represent controllers of the computer system 700.

In a variation where aspects of the invention are implemented using software, the software may be stored in a computer program product and loaded into computer system 700 using removable storage drive 714, hard disk drive 712, or communications interface 720. The control logic (software), when executed by the processor 704, causes the processor 704 to perform the functions as described herein. In another variation, aspects of the invention are implemented primarily in hardware using, for example, hardware components, such as application-specific integrated circuits (ASIC's). Implementation of the hardware state machine so as to perform the functions described herein will be apparent to persons skilled in the relevant art(s).

In yet another variation, aspects of the invention are implemented using a combination of both hardware and software.

While aspects of the present invention have been described in connection with preferred implementations, it will be understood by those skilled in the art that variations and modifications described above may be made without departing from the scope hereof. Other aspects will be apparent to those skilled in the art from a consideration of the specification or from a practice of the aspects of the invention disclosed herein.

It will be appreciated by those skilled in the art that changes could be made to the exemplary aspects shown and described above without departing from the broad inventive concept thereof. It is understood, therefore, that this invention is not limited to the exemplary aspects shown and described, but it is intended to cover modifications within the spirit and scope of the present invention as defined by the claims. For example, specific features of the exemplary aspects may or may not be part of the claimed invention and features of the disclosed aspects may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A system for tracking an orientation of an object, the system comprising:
a first sensor that measures the orientation of the object relative to an external reference frame and generates an orientation signal based on the measured orientation of the object, the first sensor being subject to drift over time;
a second sensor that receives a global positioning system (GPS) signal and generates a drift compensation signal based on the received GPS signal; and
a processor coupled to the first sensor and the second sensor, the processor generating a drift-corrected orientation signal based on the orientation signal from the first sensor and the drift compensation signal from the second sensor.

2. The system according to claim 1, wherein the second sensor is a GPS compass.

3. The system according to claim 2, wherein the GPS compass comprises at least two GPS receivers.

4. The system according to claim 1, wherein the second sensor generates an azimuth angle based on the received GPS signal.

5. The system according to claim 4, wherein the processor generating a drift-corrected orientation signal based on the azimuth angle from the second sensor.

6. The system according to claim 1, wherein the first and second sensors are mounted to the object.

7. The system according to claim 6, wherein the processor is mounted to the object.

8. The system according to claim 1, wherein the first sensor is an inertial measurement unit.

9. The system according to claim 1, wherein the first sensor compensates for pitch and roll drift of the object using a gravitational field.

10. The system according to claim 1, wherein the drift-corrected orientation signal is generated in the presence of a metallic object.

11. The system according to claim 1, wherein the processor transmits the drift-corrected orientation signal to the first sensor, the first sensor generating a second orientation signal based on the measured orientation of the object and the drift-corrected orientation signal.

12. A method for tracking an orientation of an object, the method comprising:
measuring the orientation of the object relative to an external reference frame using a first sensor;
generating an orientation signal based on the measured orientation of the object using the first sensor, the first sensor being subject to drift over time;
receiving a global positioning system (GPS) signal using a second sensor;
generating a drift compensation signal based on the received GPS signal using the second sensor; and
generating a drift-corrected orientation signal based on the orientation signal from the first sensor and the drift compensation signal from the second sensor using a processor coupled to the first and second sensor.

13. A system for tracking an orientation of an object, the system comprising:
means for measuring the orientation of the object relative to an external reference frame using a first sensor;
means for generating an orientation signal based on the measured orientation of the object using the first sensor, the first sensor being subject to drift over time;
means for receiving a global positioning system (GPS) signal using a second sensor;
means for generating a drift compensation signal based on the received GPS signal using the second sensor; and
means for generating a drift-corrected orientation signal based on the orientation signal from the first sensor and the drift compensation signal from the second sensor using a processor coupled to the first and second sensor.

14. A computer program product comprising a non-transitory computer-readable medium having control logic stored therein for causing a computer to control a tracking of an orientation of an object, the control logic comprising:
code for measuring the orientation of the object relative to an external reference frame using a first sensor;
code for generating an orientation signal based on the measured orientation of the object using the first sensor, the first sensor being subject to drift over time; and
code for receiving a global positioning system (GPS) signal using a second sensor;
code for generating a drift compensation signal based on the received GPS signal using the second sensor; and
code for generating a drift-corrected orientation signal based on the orientation signal from the first sensor and the drift compensation signal from the second sensor using a processor coupled to the first and second sensor.
